(19) United States
(12) Patent Application Publication
(10) Pub. No.: US 2024/0361283 A1
(43) Pub. Date: Oct. 31, 2024

(54) ACCESSING LARGE DATA STRUCTURES GENERATED BY SCIENTIFIC INSTRUMENTS

(71) Applicant: Thermo Finnigan LLC, San Jose, CA (US)

(72) Inventors: Thomas H. Ng, San Jose, CA (US); Trevor Hall, San Jose, CA (US)

(21) Appl. No.: 18/307,463

(22) Filed: Apr. 26, 2023

(51) Int. Cl. G01N 30/72

(52) U.S. Cl. CPC G01N 30/72

(57) ABSTRACT

Disclosed herein are scientific instrument support systems, as well as related methods, computing devices, and computer-readable media. In one example, an automated method performed via a computing device for providing scientific instrument support comprises: transferring portions of a data structure acquired with detectors of a scientific instrument to a client device, the data structure being stored in a data storage connected via a network to the computing device; identifying parts of the data structure based on a data-access pattern in a sequence of data requests; downloading the parts from the data storage to the storage device locally connected to the computing device; and switching a data transfer path for the client device from being end-connected to the data storage to being end-connected to the storage device when a requested portion of the data structure is in the parts downloaded to the storage device via the computing device.

### BACKGROUND

This application relates generally to data delivery systems, and more particularly but not exclusively, to data access and buffering.

Scientific instruments, such as, for example, imaging instruments and spectrometers, typically include a complex arrangement of components, sensors, detectors, input and output ports, energy sources, and consumable elements. Some of such scientific instruments generate relatively large volumes of data when operating, which may impact memory requirements and efficient data access.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 is a block diagram illustrating a data structure that may be generated via a scientific instrument according to some embodiments.

FIG. 2 is a block diagram illustrating a scientific instrument support system according to some embodiments.

FIG. 3 is a flowchart illustrating a method of delivering data to a client device using the scientific instrument support system of FIG. 2 according to some embodiments.

FIG. 4 is a block diagram illustrating communications and data flows involving example components of a data delivery service in the scientific instrument support system of FIG. 2 according to some embodiments.

FIG. 5 is a block diagram illustrating interactions of the data delivery service with a data-access application and a network-connected data storage in the scientific instrument support system of FIG. 2 according to some embodiments.

FIG. 6 is a block diagram illustrating a scientific instrument support module for performing scientific instrument support operations, in accordance with various embodiments.

FIG. 7 is a block diagram illustrating an example computing device that may perform some of the scientific instrument support methods and/or functions disclosed herein, in accordance with various embodiments.

FIG. 8 is a block diagram illustrating an example scientific instrument support system in which some or all of the scientific instrument support methods and/or functions disclosed herein may be performed, in accordance with various embodiments.

### DETAILED DESCRIPTION

Disclosed herein are scientific instrument support systems, as well as related methods, computing and storage devices, and computer-readable media. For example, in some embodiments, a support apparatus for a scientific instrument comprises first logic, second logic, and third logic. The first logic is configured to transfer portions of a data structure acquired with one or more detectors of the scientific instrument to a client device, the data structure being stored in a data storage connected to the first logic via a network, the portions being identified to the first logic in a sequence of data requests received from the client device. The second logic is configured to identify parts of the data structure based on at least one of a data-access pattern in the sequence of data requests and a buffer size for a storage device locally connected to the first logic. The third logic is configured to download the parts from the data storage to the storage device, wherein the first logic is configured to switch a data transfer path for the client device from being end-connected to the data storage to being end-connected to the storage device when a requested portion of the data structure is in the parts downloaded to the storage device via the third logic. In one example, client application requests to view a mass-spectrometer scan X of a raw data file stored in the cloud. This request goes to a corresponding data delivery service running in the cloud. The data delivery service determines that the data is not available locally and picks the best-performing reader out of the available set of data readers to be used for accessing the data. In parallel, the data delivery service downloads the raw data to the local storage for this service. The data delivery service sends the requested data along with additional data (for example, group related data together) determined using a predictive reading algorithm, which reduces the number of subsequent calls or eliminates the need for such calls altogether.

Scientific instrument support embodiments disclosed herein may achieve improved performance relative to conventional approaches and, for example, may achieve improved performance for time-of-flight (TOF) mass spectrometers, quadrupole mass spectrometers, ion trap mass spectrometers, and instruments including multiple spectrometers and/or detectors, for example, including ultraviolet (UV) detectors, diode array detectors (DADs, such as photodiode array detectors, PDAs), mass-spectrometer (MS) detectors, and liquid-and/or gas-chromatography detectors. For illustration purposes and without any implied limitations, some example embodiments are described below in reference to mass spectrometers. From the provided description, a person of ordinary skill in the pertinent art will be able to make and use additional support embodiments for scientific instruments employing other types of spectrometers, detectors, devices, and various combinations thereof without any undue experimentation.

TOF mass spectrometry (TOFMS) is a method of mass spectrometry in which an ion's mass-to-charge ratio is determined by a time-of-flight measurement. Ions are accelerated by an electric field of known strength. This acceleration results in an ion having the same kinetic energy as any other ion that has the same charge. The velocity of the ion depends on the mass-to-charge ratio such that heavier ions of the same charge attain lower speeds than lighter ions. The time that the ion subsequently takes to reach a downstream detector is measured. This time depends on the velocity of the ion and, as such, provides a measure of the ion's mass-to-charge ratio. From the measured TOF mass spectrum and other known experimental parameters, the composition of an analyte can be determined.

A TOF mass spectrometer may include a mass analyzer and an ion detector. An ion source (either pulsed or continuous) is used to generate ions from an analyte. The mass analyzer can be a linear flight tube or a reflectron. In various examples, the ion detector is a microchannel plate (MCP) detector or a secondary emission multiplier (SEM). The electrical signal from the ion detector is digitized with a time-to-digital converter (TDC) or an analog-to-digital converter (ADC). The TDC is a counting detector, and the ion counting performed thereby may be i accompanied by summing large numbers (e.g., hundreds) of individual mass spectra, which is sometimes referred to as histogramming. When a TDC is used, the corresponding mass analyzer may operate at a 5 kHz to 20 KHz repetition rate to generate a sufficiently large number of mass spectra to be summed. The ADC may operate at the speed of about 10 giga-samples per second to digitize the pulsed ion current from the ion detector at discrete time intervals. In various examples, the ADC has an 8-bit to 12-bit dynamic range. The use of ADCs (as opposed to TDCs) may be more beneficial for some specific types of TOF mass spectrometers, such as for Matrix-Assisted Laser Desorption/Ionization (MALDI)-TOF instruments with relatively high peak currents.

The raw data detected by a mass spectrometer are typically in the form of a signal distributed across various m/z (mass-to-charge) values where ions are detected. Centroid data include raw data that have been processed via a suitable algorithm to retain only the local maximum in each mass range in which an ion is detected. Such centroid data are often referred to as a “centroid scan.”

In some examples, a raw data file generated by a TOF mass spectrometer has a size on the order of 1 GB to 100 GB and includes data from multiple scans and/or channels in an unsegregated binary form in a file or storage format that is specifically optimized for recording, transfer, and packaging of experimental data corresponding to a single analyte injection. In a representative data storage system, such a binary data file or storage format enables a corresponding data reader associated with the instrument (e.g., provided by the instrument's manufacturer) to extract selected scan and/or channel data for further processing, e.g., in response to a request from a client device.

In an example implementation, a raw data reader (also sometimes referred to as the “data layer”) does not directly access the “final bytes” of data from any specific location. Instead, the raw data reader “knows” about (abstract) “data views” and sees such views into data originated from multiple detectors as a “view collection.” This view collection exposes to the raw data reader only limited information, such as “performance hints.” The data view abstraction allows the raw data reader to access data from any medium that is addressable in the form of “get x bytes from location y of the n-th data view”. However, the corresponding data reading mechanisms typically rely on a “system call,” which can add considerable overhead on small reads. In some examples, reading 1 byte and reading 10 KB may take approximately the same time due to the system-call overhead. The corresponding data-access delay can disadvantageously present a significant impediment to users and operators of the corresponding scientific instruments and/or systems as well as inefficient use of computing resources, including, for example, memory, processing cycles, bandwidth, or a combination thereof.

The above-indicated and possibly other related problems in the state of the art can beneficially be addressed using various examples, aspects, features, and embodiments of systems and methods for accessing scientific instrument data disclosed herein. In a representative example, a record buffer management system is designed and configured to efficiently manage large collections of records. In some examples, the record buffer management system operates in a cloud or enterprise environment to provide fast data access to client applications. In various examples, a corresponding algorithm handles records having a fixed size or variable sizes and works with a variety of different readers (e.g., is independent of the type of reader). At least some embodiments beneficially reduce data-access delays associated with some previous data-access solutions. For example, some embodiments disclosed herein may achieve improved (e.g., faster selective) access to scientific-instrument data (such as mass spectrometer scans) relative to conventional approaches.

Accordingly, embodiments disclosed herein provide improvements to the scientific instrument technology (e.g., improvements in the computer technology supporting scientific instruments, among other improvements). An example embodiment provides an automated method performed via a computing device for providing scientific instrument support. The method includes transferring portions of a data structure acquired with one or more detectors of a scientific instrument to a client device, the data structure being stored in a data storage connected via a network to the computing device, the portions being identified to the computing device in a sequence of data requests received from the client device. The method also includes identifying parts of the data structure based on at least one of a data-access pattern in the sequence of data requests and a buffer size for a storage device locally connected to the computing device and downloading the parts from the data storage to the storage device. The method further includes switching a data transfer path for the client device from being end-connected to the data storage to being end-connected to the storage device when a requested portion of the data structure is in the parts downloaded to the storage device via the computing device. Example benefits of this automated method include but are not limited to (i) reducing or eliminating long startup delays which could occur on data downloading or transfers (e.g., within cloud environments); (ii) reducing data access delays (such as the delay before the initial data are shown); and (iii) improving the data access performance, such as reducing the time to receive data corresponding to a complex request (e.g., covering a large data set).

Various ones of the embodiments disclosed herein may improve upon conventional approaches to achieve the technical advantages of improved data operations performed via the record buffer management system and with predictive data access and buffering. Such technical advantages may not be achievable by routine and conventional approaches, and all users of systems including such embodiments may benefit from these advantages (e.g., through speeding up a technical task, such as processing and analyses of experimental data). The technical features of the embodiments disclosed herein are thus decidedly unconventional in the field of instrument-related data storage, as are various combinations of the features disclosed herein. As discussed further herein, various aspects of the embodiments disclosed in this document may improve the functionality of a computer itself, for example, by operating the instrument-related data storage in an optimized manner resulting in a higher level of productivity. The computational features disclosed herein do not only involve the collection and comparison of information but apply new analytical and technical tools to change the operation of the instrument-related data storage. The present disclosure thus introduces at least some functionalities that neither a conventional computing device, nor a human, can perform.

Accordingly, embodiments of the present disclosure may serve any of a plurality of technical purposes, such as controlling a specific technical system or process; determining from measurements how to control or configure a machine; or increasing throughput of a data pipeline. Some examples disclosed herein provide solutions to technical problems, including but not limited to improvements to liquid chromatography-mass spectrometry (LC-MS) instruments, gas chromatography-mass spectrometry (GC-MS) instruments, and TOFMS instruments, e.g., improvements in the computer technology supporting such instruments, among other improvements.

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (B and C), or (A, B, and C). Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices.

The description uses the phrases “an embodiment,” “one embodiment,” “various embodiments,” and “some embodiments,” each of which may refer to one or more of the same or different embodiments. Furthermore, the terms “comprising,” “including,” “having,” and the like, as used with respect to embodiments of the present disclosure, are synonymous. When used to describe a range of values, the phrase “between X and Y” represents a range that includes X and Y. As used herein, an “apparatus” may refer to any individual device, collection of devices, part of a device, or collections of parts of devices. The drawings are not necessarily to scale.

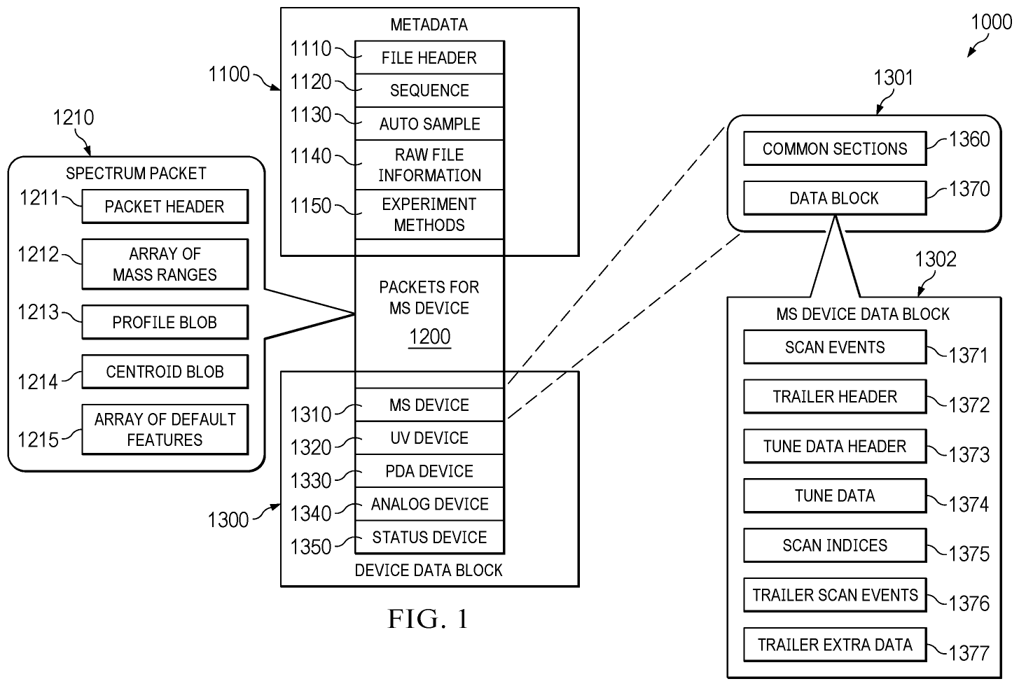

FIG. 1 is a block diagram illustrating a data structure (collection of records) 1000 generated via a scientific instrument according to an embodiment. In various examples, the data structure 1000 has a more complex structure than a single file on a disk. More specifically, in some examples, the data structure 1000 is represented by a collection of stream files or by a set of objects for a corresponding object storage mechanism. In some examples, the data structure 1000 is represented by a folder on a Linux server where each stream is saved in a separate set of files, e.g., including an index records file, a data records file, etc. At least some embodiments disclosed herein are designed to work with different storage mechanisms and the corresponding different organizations therein of the data structure 1000; that is such embodiments are independent of how the streams or blocks of data of the data structure 1000 are organized in a specific data storage system as long as the data reader “knows” the implemented data organization.

In the example shown, the data structure 1000 includes a metadata block 1100, a block of packets 1200 for the corresponding MS device, and a device data block 1300. The metadata block 1100 includes a header field 1110, a sequence field 1120, an auto sample field 1130, a raw file information field 1140, and a methods field 1150. The block of packets 1200 includes one or more spectrum packets 1210. The device data block 1300 includes one or more data fields corresponding to different specific devices of the scientific instrument used in the corresponding experiment. In the example shown, the device data block 1300 has five such device-specific data fields, which are labeled 1310-1350. In other examples, the device data block 1300 may have a different (from five) number of device-specific data fields, depending on the configuration of the corresponding scientific instrument.

In some examples, the header field 1110 includes a checksum, specifies the format version for the data structure 1000, and further includes a signature and pertinent timestamps. The sequence field 1120 includes the sample name, type, volume, and injection ID. The auto sample field 1130 includes the configuration of where the sample is stored in the auto sampler of the scientific instrument and the tray information. The raw file information field 1140 includes the device type(s) (e.g., MS, UV, etc.) and the location of the data for each of those devices. The methods field 1150 includes a description of the used experimental method, e.g., in the form of a header, descriptive information, and the method ID.

A spectrum packet 1210 has a plurality of fields including a packet header 1211, an array of mass ranges 1212, a profile blob 1213, a centroid blob 1214, and an array of default features 1215. Herein, the term “blob” (or “binary large object”) refers to a collection of binary data stored as a single entity. In some examples, blobs are used in NoSQL (not only Structured Query Language) databases, e.g., in key-value store databases, such as Redis. Some programming languages, such as JavaScript allow runtime manipulation of blobs.

Each of the device specific data fields 1310-1350 has a two-part structure illustrated in a bubble diagram 1301. The two parts of this structure are a common-sections block 1360 and a device-specific data block 1370. The common sections block 1360 has the same general structure for all devices. The device-specific data block 1370 includes a plurality of fields the structure and number of which depends on the device type. For illustration purposes, an example structure of the device-specific data block 1370 corresponding to an MS device is shown in an expansion diagram 1302. The fields of the MS device data block 1370 include a scan events field 1371, a trailer header field 1372, a tune data header field 1373, a tune data field 1374, a scan indices field 1376, and a trailer extra data field 1377.

The data structure 1000 is typically created by a corresponding scientific instrument. In some examples, the data structure 1000 has an indexed binary file format. Each of the data blocks 1100, 1200, 1300 has a respective specific layout of the bytes of the different constituent data substructures or records. A correspondingly configured data reader is used to read data from the data structure 1000. In some examples, data queries are in the form of requesting scans and chromatograms and are not SQL-like. The metadata for the metadata block 1100 are collected before the sample injection, e.g., based on a scanned bar code. Detector data are collected by the corresponding scientific instrument from all attached detectors (of various technologies). The collected data are of variable format (based on the detector technology) and variable length, with an arbitrary number of “data packets” per timed set of readings. Herein, a set of readings at a given time is referred to as a “scan.” The diagram shown in FIG. 1 illustrates a basic indexing scheme of the data structure 1000. Various additions and/or modifications to the shown basic indexing scheme may be implemented to reflect functional and/or hardware differences between different specific scientific instruments.

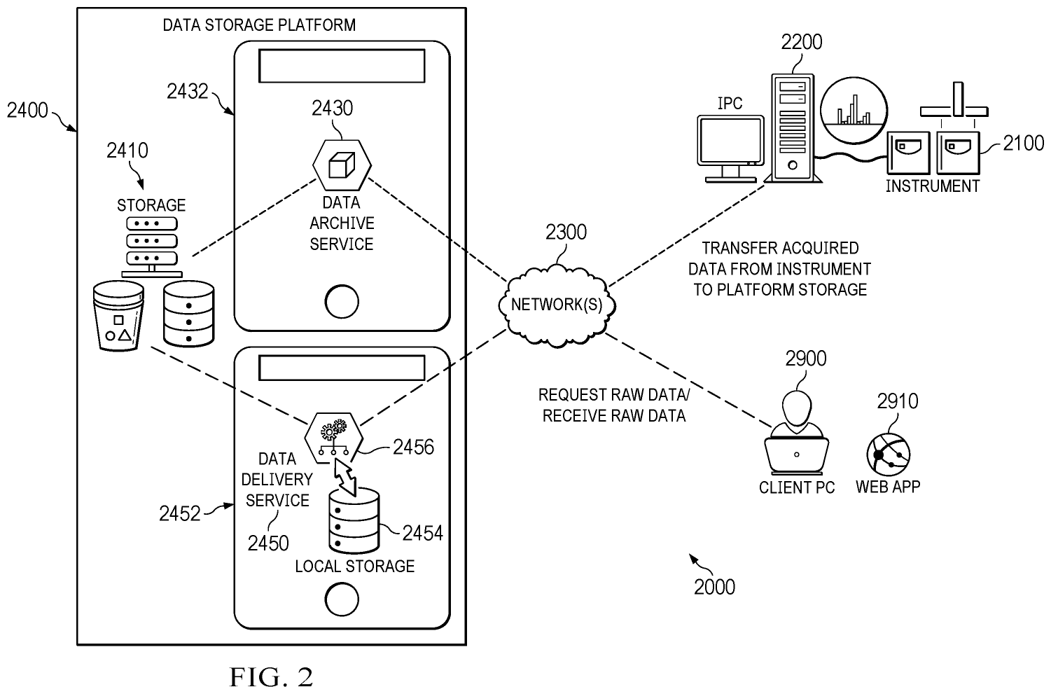

FIG. 2 is a block diagram illustrating a scientific instrument support system 2000 according to some embodiments. The system 2000 is network-connected to a scientific instrument 2100 via a network 2300 and includes a data-storage platform 2400. In some examples, the scientific instrument 2100 has a computing device 2200, such as an instrument's personal computer (IPC), through which the scientific instrument 2100 is connected to the network 2300. In some other examples, the computing device 2200 is integrated into the scientific instrument 2100 and is not present as a separate component. In the latter examples, it can be said that the scientific instrument 2100 directly connects to the network 2300.

In some embodiments, the data-storage platform 2400 is a cloud platform. However, various embodiments are not so limited. Various additional embodiments of the data-storage platform 2400 include a web-based object storage (such as the object storage available through Amazon Web Services (AWS), Google Cloud Platform (GCP), Microsoft Azure, or similar services), an enterprise data-storage platform, and a micro service platform. Some micro service platforms may be in the form of a computing appliance, server rack, or on-premises data storage.

In the example shown, the data-storage platform 2400 includes a data-storage subsystem 2410, a data archive service 2430, and a data delivery service 2450. In some examples, the data-storage subsystem 2410 includes a network-attached storage (NAS) that enables multiple users and heterogeneous client devices to retrieve data from the constituent memory capacity. Users on a local area network (LAN) can access the NAS via a standard Ethernet connection. NAS devices typically do not have a keyboard or display and are configured and managed via a browser-based utility. In an example configuration, a NAS resides on the LAN as an independent network node, defined by its own unique IP address. In some other examples, the data-storage subsystem 2410 includes a storage area network (SAN). SANs are typically used to provide access to a pool of shared storage to multiple computers and servers. Such storage appears to the computers on the network as direct-attached storage. In an example configuration, a SAN removes the storage responsibility from individual servers and collects it in a central place where it can be accessed, managed, and protected. Connecting storage to servers through a network separate from the traditional LAN can be used, e.g., to optimize storage traffic performance, as the corresponding storage traffic does not compete for LAN bandwidth with servers and workloads. In some examples, a NAS is preferred for handling substantially unstructured data, whereas a SAN is preferred for block storage inside databases or to serve enterprise applications.

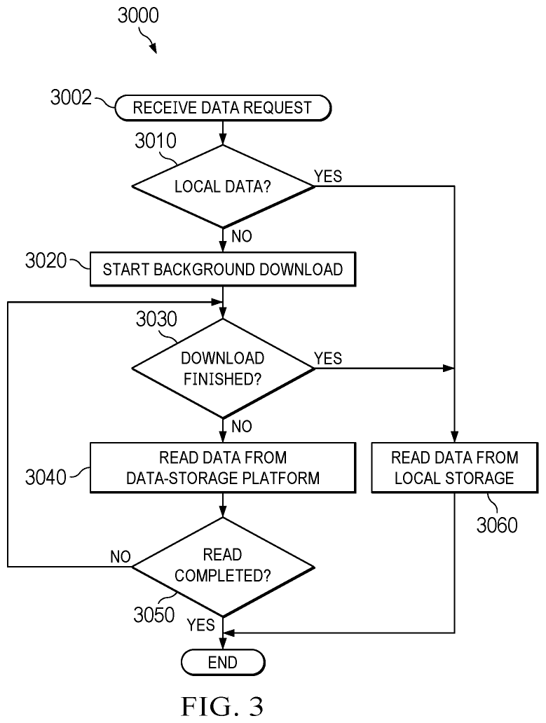

In some examples, the data archive service 2430 runs on a server or other suitable computing device 2432. The corresponding program code causes the computing device 2432 to appropriately organize and transfer various instances of the data structure 1000 acquired via the scientific instrument 2100 for storage in the data-storage subsystem 2410. The data delivery service 2450 runs on a server or other suitable computing device 2452. The computing device 2452 has a local storage device 2454 connected thereto. In operation, the data delivery service 2450 operates to provide data from one or more data structures 1000 stored in the data-storage subsystem 2410 to a client device 2900 in response to a data request received therefrom. In some examples, the data request is generated by the client device 2900 using a data-access application 2910. Various example embodiments of the data delivery service 2450 are described in more detail below in reference to FIGS. 3-8.

Herein, the term “local storage” refers to a memory device that is directly connected to the computing device 2452. In some examples, the local storage device 2454 does not rely on a network to send data to or receive data from the computing device 2452. In various examples, the physical hardware of the local storage device 2454 includes a flash drive, a hard disk drive (HDD), a solid-state drive (SDD), and/or a compact disk (CD) drive. Once data are stored in the local storage device 2454, those data can only be accessed therein through the computing device 2452. For example, when the computing device 2452 is turned OFF, the data stored in the local storage device 2454 is not typically accessible. In some examples, the physical distance between the computing device 2452 and the local storage device 2454 is less than approximately 10 m. In some examples, the local storage device 2454 is integrated in the computing device 2452. In some examples, the local storage device 2454 has one or more of the following characteristics. The local storage device 2454 does not need, have, use, or rely on an Ethernet connection. The local storage device 2454 is configured to be used as virtual memory by an operating system (OS), e.g., in accordance with the page file system file used by the Windows operating system. Due to the local storage being a part of the paging system, OS level page management can make memory mapping over such storage more efficient. Software may be configured or choose to use an alternative reading technology (such as, a Random-Access File Reader, e.g., as indicated below) for a remote or network attached storage device, such as the data-storage subsystem 2410.

In operation, the scientific instrument 2100 generates one or more data structures 1000 by acquiring experimental data corresponding to one or more analytes via the one or more detectors thereof. In some specific examples, the scientific instrument 2100 is a TOFMS or LC-MS instrument. As indicated above, to perform the data acquisition, ions generated via the ion source of the instrument are directed through the mass analyzer and detected via one or more detectors of the instrument. Accordingly, the scientific instrument 2100 may acquire the data at one or more settings of the mass analyzer and detector(s). The scientific instrument 2100 may then include one or more parameters associated with the settings into the corresponding data structures 1000.

For example, the scientific instrument 2100 may apply automated processing to the acquired raw detector data. Such automated processing typically includes generating a metadata block 1100 for the corresponding data structure 1000 based on one or more parameters associated with the settings of the scientific instrument 2100 and various detectors thereof. In some examples, the automated processing includes some or all of the following operations: (a) assembling different data portions of the raw data stream(s) into records; (b) segregating different data streams of the raw data file(s) into one or more streams of records; and (c) further segregating streams into groups. The data archive service 2430 then handles the transfer of records assembled into the corresponding data structure(s) 1000 from the scientific instrument 2100 to the data-storage subsystem 2410 of the data-storage platform 2400. In various examples, such transfer of the records occurs via the computing device 2200 or directly from the from the scientific instrument 2100 itself.

FIG. 3 is a flowchart illustrating a method 3000 of delivering data to the client device 2900 with the system 2000 according to some embodiments. The method 3000 is described below in continuing reference to FIG. 2. The method 3000 is initiated in a start block 3002 when the data delivery service 2450 receives a data request from the client device 2900. The received data request typically identifies a requested portion of the corresponding data structure 1000.

The method 3000 includes the data delivery service 2450 determining, in a decision block 3010, whether the requested data are available locally, i.e., in the local storage device 2454. When the requested data are not available locally (“No” at the decision block 3010), the method 3000 performs operations of a block 3020. When the requested data are available locally (“Yes” at the decision block 3010), the method 3000 performs operations of a block 3060.

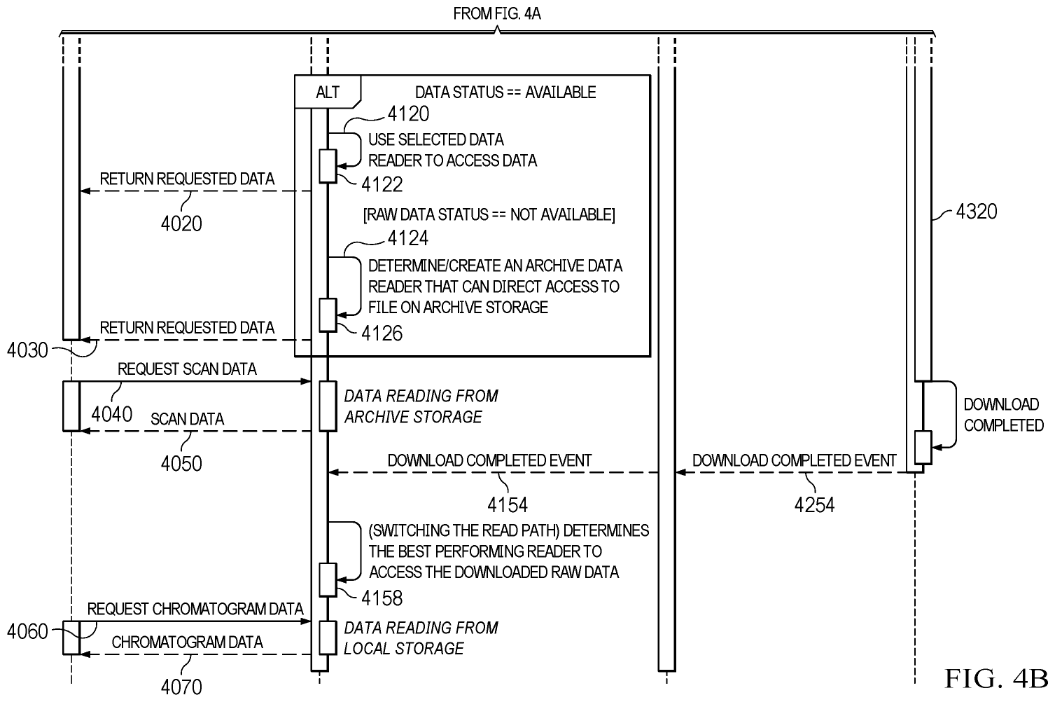

In the block 3020, the data delivery service 2450 starts a background download, in which a specified data chunk is downloaded to the local storage device 2454 from the data-storage subsystem 2410. In various examples, the specified data chunk typically includes the data requested in the start block 3002. In some examples, the specified data chunk includes more data than the data requested in the start block 3002, with the additional data being determined using a predictive reading algorithm. Various examples of the predictive reading algorithm are described below, e.g., in reference to FIG. 5.

In a decision block 3030 of the method 3000, the data delivery service 2450 monitors the progress of the background download started in the block 3020. When it is determined that the background download is still in progress (not completed; “No” at the decision block 3030), the method 3000 performs operations of a block 3040. When the download is completed (“Yes” at the decision block 3030), the method 3000 performs operations of the block 3060.

In the block 3040, the data delivery service 2450 uses a suitably selected data reader to read, from the data-storage subsystem 2410, portions of the data corresponding to the request received in the start block 3002. The data delivery service 2450 then directs the obtained data portions to the client device 2900.

In a decision block 3050 of the method 3000, the data delivery service 2450 monitors the progress of the read-and-transfer operations towards the fulfillment of the data request, i.e., to a state in which the entirety of the requested data is transferred to the client device 2900. When the read-and-transfer operations are not yet completed (“No” at the decision block 3050), the method 3000 is directed back to performing the operations of the block 3030. When the read-and-transfer operations are completed (“Yes” at the decision block 3050), the method 3000 is terminated.

In the block 3060, the data delivery service 2450 uses a suitably selected data reader to read, from the local storage device 2454, portions of data corresponding to the request received in the start block 3002. The data delivery service 2450 then directs the obtained data portions to the client device 2900. Note that the data reader selected to read from the local storage device 2454 in the block 3060 is typically different from the data reader selected to read from the data-storage subsystem 2410 in the block 3030. Depending on the processing route through which the method 3000 arrives at the operations of the block 3060, the read-and-transfer operations of the block 3060 may encompass the entirety of the requested data (e.g., for the route from the decision block 3010) or less than the entirety of the requested data (e.g., for the route from the decision block 3030). When the read-and-transfer operations of the block 3060 are completed, the method 3000 is terminated.

In some examples, the data delivery service 2450 has a dynamic data-reader selector 2456 (see FIG. 2) using which the data delivery service 2450 selects a suitable data reader, e.g., for the blocks 3040 and 3060, from a plurality of available data readers. In operation, the dynamic data-reader selector 2456 may determine and select an approximately best-performing reader for the specific data access path. For example, as already indicated above, different respective data readers are typically selected for reading from the data-storage subsystem 2410 and for reading from the local storage device 2454. In some examples, the dynamic data-reader selector 2456 operates to switch from one data reader to a different data reader when operations of the method 3000 are redirected from the block 3040, via the decision blocks 3050 and 3030, to the block 3060. The data-access application 2910 running on the client device 2900 is typically unaware of such data-reader switches because the data delivery service 2450 and its dynamic data-reader selector 2456 are in a better position to dynamically change the data reader for the purpose of achieving a corresponding performance boost for the benefit of the data-requesting user.

In some examples, the dynamic data-reader selector 2456 is implemented using a plugin framework based on which different data readers are available to the data delivery service 2450 as different application plugins. The plugin framework enables customization and adaptation of the data delivery service 2450 for handling a variety of different storage technologies. The plugin framework also provides standard interfaces to load custom data readers into the existing data reading system. Representative examples of data-reader plugins available to the dynamic data-reader selector 2456 include, but are not limited to, (i) a Memory Array Reader plugin; (ii) a Memory Map File Reader plugin; (iii) an S3 Reader plugin; and (iv) a Random-Access File Reader plugin.

For example, the Simple Storage Service (S3) is an object storage service that offers good scalability, security, and performance. An object storage service stores data as objects within buckets. An object is a file associated with any metadata that describe that file. A bucket is a container for objects. To store data in S3, one first creates a bucket and specifies the bucket's name and storage domain. The procedure for saving the object depends on the browser and operating system. For example, Amazon's S3 is a key-value store, which is one of the categories of NoSQL databases used for accumulating voluminous, mutating, unstructured, or semi-structured data. Uploaded objects are referenced therein by a unique key, which can be a string.

As another example, a memory-mapped file contains the contents of a file in virtual memory. The mapping between a file and a memory space enables an application, e.g., including multiple processes, to modify the file by reading and writing directly to the memory. There are two types of memory-mapped files: persisted files and non-persisted files. Persisted files are memory-mapped files that are associated with a source file on a disk. When the last process has finished working with the file, the data are saved to the source file on the disk. These memory-mapped files are suitable for working with large source files. Non-persisted files are memory-mapped files that are not associated with a file on a disk. When the last process has finished working with the file, the data are lost, and the memory space may be reclaimed by garbage collection. These files are suitable for creating shared memory for inter-process communications. To work with a memory-mapped file, one creates a view of the entire memory-mapped file or a pertinent part thereof. Multiple views may be created, e.g., when the file is greater than the size of the application's logical memory space available for memory mapping. There are two types of views: stream access views and random-access views. Stream access views are used for sequential access and are recommended for non-persisted files and inter-process communications. Random access views are preferred for working with persisted files. Memory-mapped files are accessed through the operating system's memory manager, and the file is automatically partitioned into pages and accessed as needed.

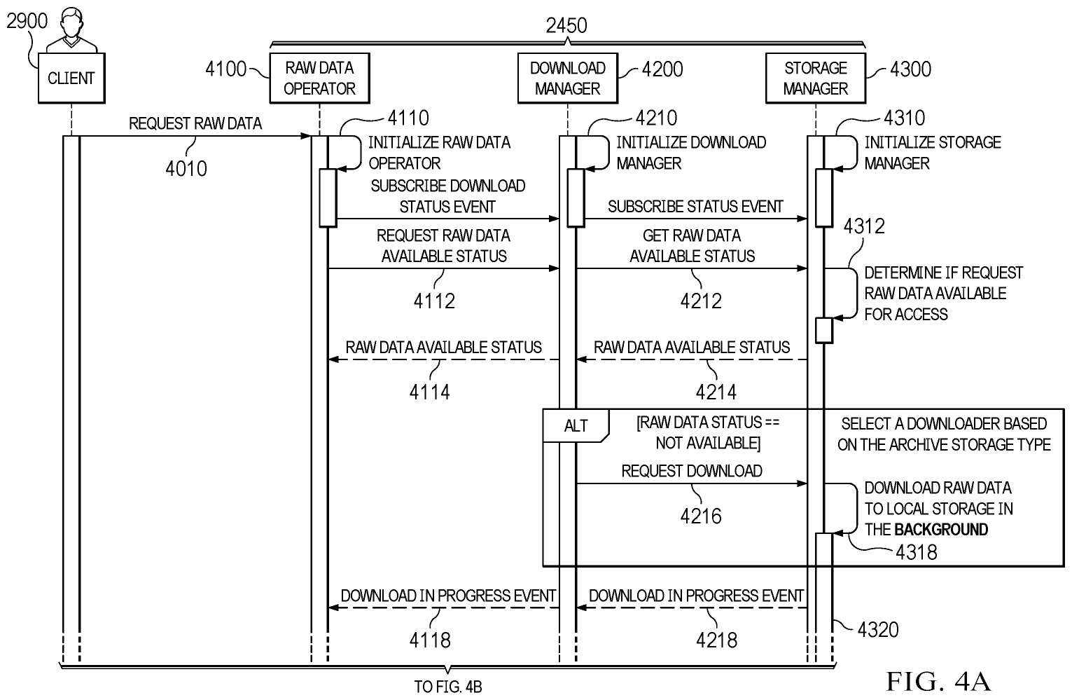

FIG. 4 is a block diagram illustrating communications and data flows involving example components of the data delivery service 2450 according to some embodiments. In at least some examples, the communications and data flows illustrated in FIG. 4 may be in accordance with the method 3000. As an example, FIG. 4 illustrates certain operations of data delivery service 2450 in response to data requests 4010, 4040, and 4060 received from the client device 2900 at different respective times.

In the example shown, the data delivery service 2450 includes the following functional modules: a raw data operator 4100, a download manager 4200, and a storage manager 4300. The raw data operator 4100 communicates with the download manager 4200 to initiate actions, selects and operates appropriate data readers, directs requested data to the client device 2900, and is responsible for at least some of the operations of the blocks 3040, 3060 of the method 3000. The download manager 4200 and the storage manager 4300 communicate with the raw data operator 4100 and are responsible for at least some of the operations of the blocks 3020, 3030 of the method 3000.

In response to receiving the data request 4010 from the client device 2900, the data delivery service 2450 performs initializations 4110, 4210, and 4310 of the respective instances of the raw data operator 4100, the download manager 4200, and the storage manager 4300. After the initializations 4110, 4210, and 4310 are completed, the raw data operator 4100 sends a message 4112 requesting the availability status of the data corresponding to the data request 4010. In response to the message 4112, the download manager 4200 sends a corresponding message 4212 instructing the storage manager 4300 to determine the availability status of the requested data in the local storage device 2454. Upon making a corresponding determination 4312, the storage manager 4300 sends a status reporting message 4214 to the download manager 4200, which further sends a corresponding reporting message 4114 to the raw data operator 4100. Depending on the specific example, the availability status reported via the messages 4214, 4114 is either “available” or “not available.”

When the reported availability status is “available,” the raw data operator 4100 makes a selection 4120 to select a suitable data reader for reading the requested data from the local storage device 2454. In some examples, the data reader selected via the selection 4120 is an optimal data reader, e.g., the data reader providing approximately the best performance. The raw data operator 4100 then uses the selected data reader to perform memory read operations 4122 to read the requested data from the local storage device 2454. The raw data operator 4100 directs the obtained data via a data stream 4020 to the client device 2900.

When the reported availability status is “not available,” the raw data operator 4100 makes a selection 4124 to select a suitable data reader for reading the requested data from the data-storage subsystem 2410. The raw data operator 4100 then uses the selected data reader to perform memory read operations 4126 to read the requested data from the data-storage subsystem 2410. The raw data operator 4100 directs the obtained data via a data stream 4030 to the client device 2900.

The “not available” status reported via the message 4214 also causes the download manager 4200 to send a message 4216 requesting that the storage manager 4300 start a background download (also see the block 3020, FIG. 3). In response to the message 4216, the storage manager 4300 makes a selection 4318 to select a suitable downloader for downloading a data chunk from the data-storage subsystem 2410. The storage manager 4300 then uses the selected downloader to perform data download operations 4320 to read the data chunk from the data-storage subsystem 2410. As already indicated above in the description of the block 3020, the data chunk includes at least the data requested in the data request 4010. In some examples, the data chunk includes more data than the data requested in the data request 4010, with the additional data being determined using a predictive reading algorithm. Once the download operations 4320 are started, the storage manager 4300 sends a message 4218 reporting to the download manager 4200 that the download event is in progress, which is then relayed, as a message 4118, to the raw data operator 4100. When the data download operations 4320 are completed, the storage manager 4300 sends a message 4254 reporting to the download manager 4200 that the download event has concluded, which is then relayed, as a message 4154, to the raw data operator 4100.

In the example shown, both data requests 4040 and 4060 request data covered by the download operations 4320. The respective times of the data requests 4040 and 4060 are before and after the time of the reporting messages 4254/4154. Therefore, for the data request 4040, the availability status of the requested data is “not available.” Accordingly, the raw data operator 4100 proceeds to read the requested data from the data-storage subsystem 2410 and then operates to direct the obtained data via a data stream 4050 to the client device 2900. In contrast, for the data request 4060, the availability status of the requested data is “available.” Accordingly, the raw data operator 4100 proceeds to read the requested data from the local storage device 2454 and then operates to direct the obtained data via a data stream 4070 to the client device 2900. The raw data operator 4100 implements a corresponding switch 4158 of the data reader and of the data access path after the reporting message 4154 is received and then uses the local data reader and path to fulfill the data request 4060.

General concepts of the above-mentioned predictive reading can be illustrated using the following example: Suppose that a data retrieval algorithm is stepping though one million MS scans, each of which contains approximately 10 KB. Approximately one hundred MS scans can be read in one system call. A predictive reading mechanism is efficient when several of the one hundred MS scans will be requested by the client device 2900. Because typical algorithms for processing raw data running on the client device 2900 are configured to travel forward through a collection of scans, a predictive lookahead from the point of view of the MS data processing algorithm can be used to speed up the data delivery. For example, MS scans 201-300 can be predictively read while MS scans 101-200 are being processed. In some examples, the batch size is dynamic. In various examples, the retrieved records can be of many types, such as scan, scan index, status log, and so on. In some cases this lookahead can be longer, allowing (for example) MS scans 301 to 400 to be predictively read while any data in ranges 1-100, 101-200, 201-300 are being processed, up to a built in limit, such as “3 buffered ranges”.In some cases, the total amount of data for all scans in the file may be not more than “the size of all held buffers” plus “the size of a predicted buffer”. In an example case where 3 delivered buffers and one predictive buffer is permitted, memory is reserved for 4 buffers at any time. This leads to a simplification “if all data fits in ≤4 buffers, then keep all data in memory.” Holding all data in memory can be an advantage where an algorithm makes multiple passes over data.

FIG. 5 is a block diagram illustrating interactions of the data delivery service 2450 with the data-access application 2910 running on the client device 2900 and with the data-storage subsystem 2410 according to some embodiments. The block diagram of FIG. 5 explicitly shows a predictive algorithm module 5100 of the data delivery service 2450 as well as other above-described components thereof (i.e., 2454, 2456, FIG. 2; 4100, 4200, 4300, FIG. 4). The data-access application 2910 communicates with the raw data operator 4100 to request and receive data stored in various instances of the data structure 1000. The raw data operator 4100 operates to select appropriate data reader plugins via the dynamic data-reader selector 2456. For example, different respective data reader plugins can be used by the raw data operator 4100 for reading data from the cloud-based data-storage subsystem 2410 and from the local storage device 2454, e.g., as described above. The download manager 4200 and the storage manager 4300 communicate with the raw data operator 4100 and implement background downloads from the cloud-based data-storage subsystem 2410 to the local storage device 2454, e.g., as described above, to enable the raw data operator 4100 to switch the data-delivery route between a network path 5200 and a local path 5300. The predictive algorithm module 5100 is used to select the data chunks for the background downloads, e.g., as described in more detail below.

Suppose the data structure 1000 has one million MS scans. On one hand, it is inefficient to read those MS scans one at a time. On the other hand, it is also inefficient and might be not even technically feasible for the data delivery service 2450 to cache all one million MS scans. Therefore, the predictive algorithm module 5100 is used to determine an optimal number of MS scans for the background download to ensure efficient delivery of the requested MS scans to the data-access application 2910. The predictive algorithm 5100 is hidden from the calling code of the data-access application 2910, which typically operates to ask for MS scans as needed. In various examples, the amounts of memory (e.g., buffer sizes) allocated to the background downloads (data read per call) can be tuned based on the specifics of the corresponding data reading protocol, data structure 1000, and other pertinent configuration parameters.

In some examples, the predictive algorithm module 5100 is configured to determine the buffer size based on several factors. For example, a usable hint, such as the “Suggested Buffer Size” (bytes), may come from a read accessor. Hence, the S3 reading and the local-disk reading may prompt different respective buffer sizes. In some examples, the predictive algorithm module 5100 operates using a combination of information from the “Suggested Buffer Size” of the selected data reader and “the estimated average record length.” In particular, the predictive algorithm module 5100 estimates how many records will fit into each buffer based on the suggested buffer size and the average record length. In some examples, the buffer size approximately corresponds to the data chunk size of the corresponding background download.

In some examples, one or more buffers are shared among multiple concurrent reading threads. An example implementation uses spinlocks or similar concurrency-supporting mechanisms, depending on the specific programming language used. For example, when the data delivery service 2450 attempts to find a block of available records which contains a requested record, a spinlock may be appropriate. No costly work (such as memory allocations) is done within the spinlock. There is only a relatively small number (for example three) of buffers that are kept active. As a result, searches of the general form “is the requested record in any loaded buffer?” are relatively fast.

Herein, a spinlock is a low-level synchronization mechanism suitable for use on shared memory multiprocessors. When the calling thread requests a spinlock that is already held by another thread, the second thread spins in a loop to test if the lock has become available. When the lock is obtained, it is held only for a short time, as the spinning wastes processor cycles. Callers unlock spinlocks before calling other operations to enable other threads to obtain the lock.

In some examples, the predictive algorithm module 5100 is configured to find and analyze patterns in the streams of data requests from the data-access application 2910. When a next data request is in accordance with one of the found patterns, the predictive algorithm module 5100 operates to make a prediction for future data requests based on that pattern. A corresponding background download may then be initiated, e.g., as described above, based on the prediction and the data-chunk size corresponding to the prediction. When a next data request is not in accordance with one of the found patterns, no new prediction is made, and the raw data operator 4100 continues to read the requested data without a new prediction.

For example, when MS scan X1 is requested by the data-access application 2910, the predictive algorithm module 5100 prompts the data delivery service 2450 to also obtain MS scans X2 and X3 based on the detected pattern in the corresponding stream of data requests. This prediction is made based on MS-specific attributes (e.g., parameters and/or criteria), such as the scan order in a sequence of MS scans, a sequence of requested mass ranges, scan's timing with respect to the timing of a selected chromatographic peak or sequence of chromatographic peaks, etc. While cache prefetching is sometimes used in some CPU architectures, such cache prefetching is not related to or based on MS-specific parameters or criteria. For example, prefetching in a CPU architecture is typically related to CPU instructions and memory blocks and is not concerned with MS scans, mass ranges, or chromatographic peaks.

In some examples, a data structure 1000 may contain around one million MS scans. Analyses of a single sample may involve a search for about one thousand or even several thousands of compounds from a corresponding chemical “compound library.” Representative examples of the chemical compound library are a library of known pollutants and a library of metabolites of prohibited substances (e.g., in doping control testing). In an LC-MS instrument, those library compounds may elute at different times. The elution time for each compound can be estimated using a typically expected elution time under standard conditions and a time window attached to the expected elution time, with the width of the time window accounting for uncontrollable environmental differences or deviations from the standard conditions. In practice, the time windows representing different chemical compounds may overlap. In some examples, the predictive algorithm module 5100 is configured to use lists from the pertinent library to identify the time windows needed to load the MS scans for the corresponding sample analyses. In other words, the predictive algorithm module 5100 can prompt background downloads that enable rapid analyses for scanning the pertinent chemical compound library given an indication that the data-access application 2910 is used in conjunction with that chemical compound library. In various examples, such an indication may be given to the predictive algorithm module 5100 via an explicit message from the data-access application 2910 or inferred from the detected pattern in the corresponding sequence of data requests.

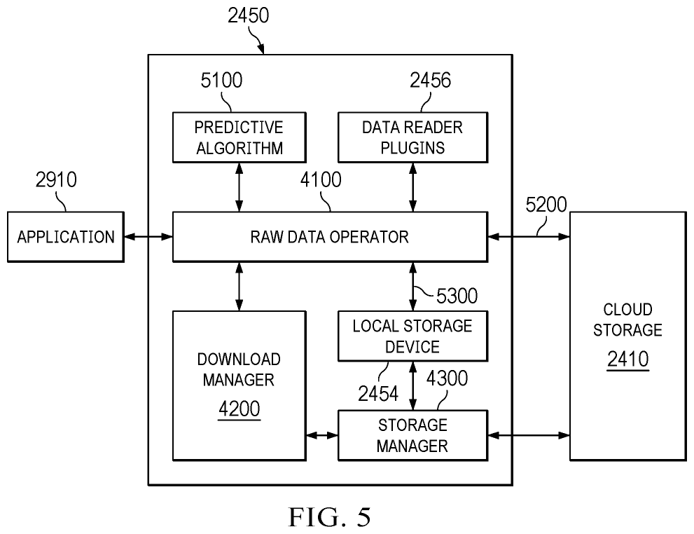

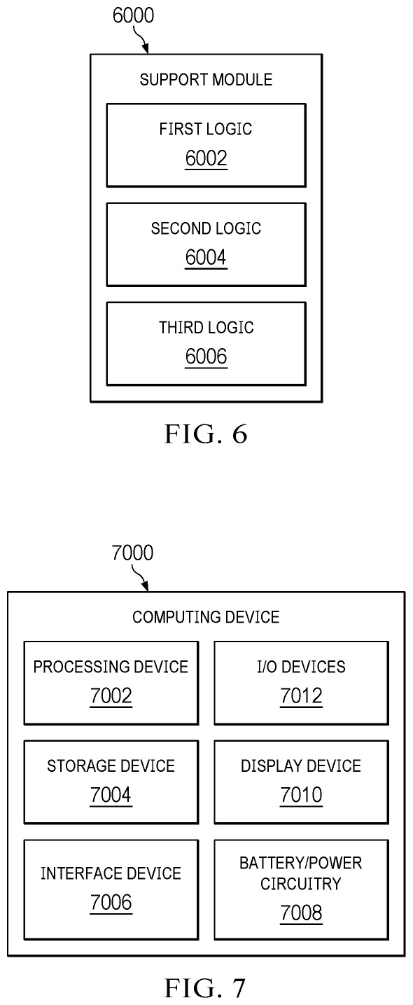

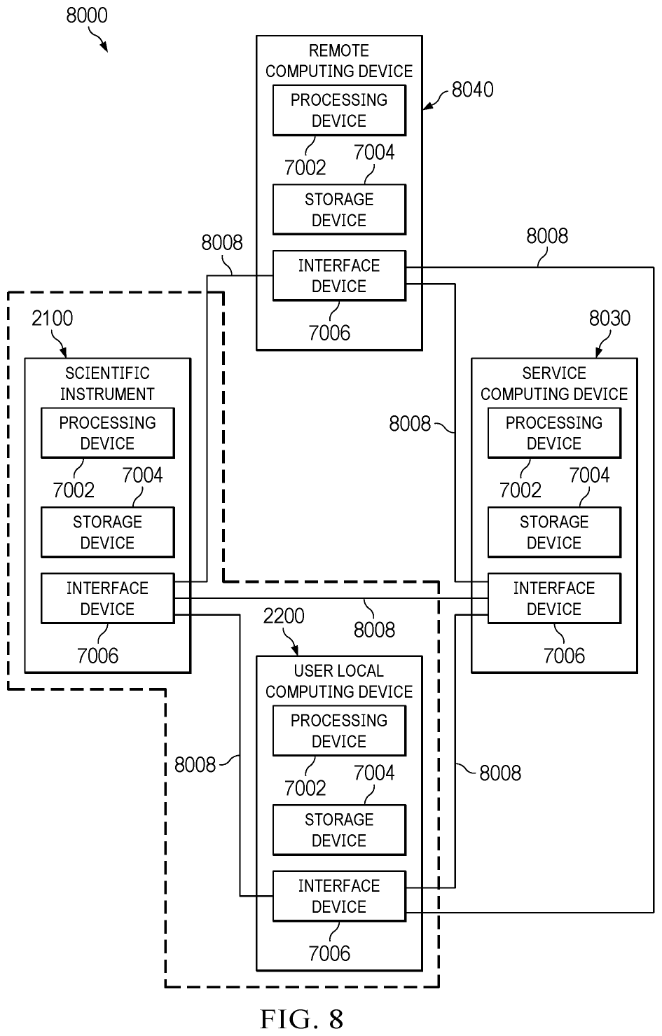

FIG. 6 is a block diagram illustrating a scientific instrument support module 6000 for performing scientific instrument support operations, in accordance with various embodiments. The scientific instrument support module 6000 may be implemented by circuitry (e.g., including electrical and/or optical components), such as a programmed computing device. The logic of the scientific instrument support module 6000 may be included in a single, common computing device or may be distributed across multiple computing devices that are in communication with each other as appropriate. Examples of computing devices that may, singly or in combination, implement the scientific instrument support module 6000 are discussed herein with reference to a computing device 7000 of FIG. 7, and examples of systems of interconnected computing devices, in which the scientific instrument support module 6000 may be implemented across one or more of the computing devices, are discussed herein with reference to the scientific instrument support system 8000 of FIG. 8.

As illustrated in FIG. 6, the scientific instrument support module 6000 includes first logic 6002, second logic 6004, and third logic 6006 for performing support methods as described herein for the scientific instrument 2100, such as, for example, a TOFMS or LC-MS instrument. As used herein, the term “logic” may include an apparatus that is configured to perform a set of operations associated with the logic. For example, any of the logic elements included in the scientific instrument support module 6000 may be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform a function associated with the module. Different ones of the logic elements in a module may take the same form or may take different forms. For example, some logic in a module may be implemented by a programmed general-purpose processing device, while other logic in the module may be implemented by an application-specific integrated circuit (ASIC). In another example, different ones of the logic elements in a module may be associated with different sets of instructions executed by one or more processing devices. A module may not include all of the logic elements depicted in the associated drawing. For example, a module may include a subset of the logic elements depicted in the associated drawing when that module is to perform a subset of the operations discussed herein with reference to that module.

The first logic 6002 may transfer portions of the data structure 1000 acquired with one or more detectors of the scientific instrument 2100 to the client device 2900. As already indicated above, the data structure 1000 is stored in the data-storage subsystem 2410, which may be network-connected to the first logic 6002. The portions of the data structure 1000 for the transfer are identified to the first logic 6002 in a sequence of data requests received from the client device 2900. In some examples, the first logic 6002 is configured to perform at least some of the functions of the raw data operator 4100.

The second logic 6004 may identify and select certain parts (data chunks) of the data structure 1000 based on at least one of a data-access pattern in the sequence of data requests from the client device 2900 and a buffer size for the local storage device 2454. In some examples, the second logic 6004 is configured to perform at least some of the functions of the predictive algorithm module 5100.

The third logic 6006 may download the parts (data chunks) of the data structure 1000 identified and selected by the second logic 6004 from the data-storage subsystem 2410 to the local storage device 2454. In some examples, the third logic 6006 may perform a background download to download such parts, with the background download occurring concurrently with the transfer via the first logic 6002 of one or more of the portions of the data structure 1000 from the data-storage subsystem 2410 to the client device 2900. In some examples, the third logic 6006 is configured to perform at least some of the functions of the download manager 4200 and the storage manager 4300 (also see FIG. 4).

FIG. 7 is a block diagram of a computing device 7000 that may perform at least some of the scientific instrument support functions and/or methods disclosed herein, in accordance with various embodiments. In some embodiments, the data delivery service 2450 may be implemented using a single computing device 7000 or multiple computing devices 7000. Further instances of the computing device 7000 (or of multiple computing devices 7000) may be used to implement parts of one or more of the scientific instrument 2100, computing device 2200, client device 2900, and data archive service 2430.

The computing device 7000 of FIG. 7 is illustrated as having a number of components, but any one or more of those components may be omitted or duplicated, as suitable for the application and/or setting. In some embodiments, some or all of the components included in the computing device 7000 may be attached to one or more motherboards and enclosed in a housing (e.g., including plastic, metal, and/or other materials). In some embodiments, some of these components may be fabricated onto a single system-on-a-chip (SoC) (e.g., an SoC may include one or more processing devices 7002 and one or more storage devices 7004). Additionally, in various embodiments, the computing device 7000 may not include one or more of the components illustrated in FIG. 7, but may include interface circuitry (not explicitly shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 7000 may not include a display device 7010, but may include display device interface circuitry (e.g., a connector and driver circuitry) to which a display device 7010 may be externally coupled.

The computing device 7000 may include a processing device 7002 (e.g., one or more processing devices). As used herein, the term “processing device” may refer to any device or portion of a device that processes electronic data from registers and/or memory to transform that electronic data into other electronic data that may be stored in registers and/or memory. The processing device 7002 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 7000 may include a storage device 7004 (e.g., one or more storage devices). The storage device 7004 may include one or more memory devices such as random-access memory (RAM) devices (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 7004 may include memory that shares a die with a processing device 7002. In such an embodiment, the memory may be used as cache memory and may include embedded dynamic random-access memory (eDRAM) or spin transfer torque magnetic random access memory (STT-MRAM), for example. In some embodiments, the storage device 7004 may include non-transitory computer readable media having instructions thereon that, when executed by one or more processing devices (e.g., the processing device 7002), cause the computing device 7000 to perform any appropriate ones or portions of the methods disclosed herein.

The computing device 7000 may include an interface device 7006 (e.g., one or more interface devices 7006). The interface device 7006 may include one or more communication chips, connectors, and/or other hardware and software to govern communications between the computing device 7000 and other computing devices. For example, the interface device 7006 may include circuitry for managing wireless communications for the transfer of data to and from the computing device 7000. Herein, the term “wireless” and its derivatives are used to describe circuits, devices, systems, methods, techniques, communications channels, etc., that may communicate data using modulated electromagnetic radiation transmitted through a nonsolid medium. The term does not imply that the associated devices do not contain any wires, although in some embodiments they might not. Circuitry included in the interface device 7006 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In some embodiments, circuitry included in the interface device 7006 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 7006 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 7006 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 7006 may include one or more antennas (e.g., one or more antenna arrays) to receipt and/or transmission of wireless communications.

In some embodiments, the interface device 7006 may include circuitry for managing wired communications, such as electrical, optical, or any other suitable communication protocols. For example, the interface device 7006 may include circuitry to support communications in accordance with Ethernet technologies. In some embodiments, the interface device 7006 may support both wireless and wired communication, and/or may support multiple wired communication protocols and/or multiple wireless communication protocols. For example, a first set of circuitry of the interface device 7006 may be dedicated to shorter-range wireless communications such as Wi-Fi or Bluetooth, and a second set of circuitry of the interface device 7006 may be dedicated to longer-range wireless communications such as global positioning system (GPS), EDGE, GPRS, CDMA, WiMAX, LTE, EV-DO, or others. In some embodiments, a first set of circuitry of the interface device 7006 may be dedicated to wireless communications, and a second set of circuitry of the interface device 7006 may be dedicated to wired communications.

The computing device 7000 may include battery/power circuitry 7008. The battery/power circuitry 7008 may include one or more energy storage devices (e.g., batteries or capacitors) and/or circuitry for coupling components of the computing device 7000 to an energy source separate from the computing device 7000 (e.g., AC line power).

The computing device 7000 may include a display device 7010 (e.g., multiple display devices). The display device 7010 may include any visual indicators, such as a heads-up display, a computer monitor, a projector, a touchscreen display, a liquid crystal display (LCD), a light-emitting diode display, or a flat panel display.

The computing device 7000 may include other input/output (I/O) devices 7012. The other I/O devices 7012 may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 7000, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 7000 may have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.), a desktop computing device, or a server computing device or other networked computing component.

In some examples, the computing device 7000 is implemented using a plurality of pods in a Kubernetes cluster. A representative Kubernetes cluster comprises a plurality of computer nodes configurable to host multiple pods, each functioning as a virtual machine. In various deployments, several instances of a micro-service can be run on a single pod or on multiple pods. In some examples, better performance is achieved when some of the multiple pods are distributed across different computer nodes.

FIG. 7 is a block diagram of an example scientific instrument support system 8000 in which some or all of the scientific instrument support methods disclosed herein may be performed, in accordance with various embodiments. The scientific instrument support modules and methods disclosed herein may be implemented by one or more of the scientific instrument 2100, the user local computing device 2200, a service computing device 8030, and a remote computing device 8040 of the scientific instrument support system 2000.

Any of the scientific instrument 2100, the user local computing device 2200, the service computing device 8030, or the remote computing device 8040 may include any of the embodiments of the computing device 7000 discussed herein with reference to FIG. 7. The scientific instrument 2100, the user local computing device 2200, the service computing device 8030, and/or the remote computing device 8040 may each include a respective processing device 7002, a respective storage device 7004, and a respective interface device 7006. The processing device 7002 may take any suitable form, including the form of any of the processing devices 7002 discussed herein with reference to FIG. 7, and the processing devices 7002 included in different ones of the scientific instrument 2100, the user local computing device 2200, the service computing device 8030, or the remote computing device 8040 may take the same form or different forms. The storage device 7004 may take any suitable form, including the form of any of the storage devices 7004 discussed herein with reference to FIG. 7, and the storage devices 7004 included in different ones of the scientific instrument 2100, the user local computing device 2200, the service computing device 8030, or the remote computing device 8040 may take the same form or different forms. The interface device 7006 may take any suitable form, including the form of any of the interface devices 7006 discussed herein with reference to FIG. 7, and the interface devices 7006 included in different ones of the scientific instrument 2100, the user local computing device 2200, the service computing device 8030, or the remote computing device 8040 may take the same form or different forms.

The scientific instrument 2100, the user local computing device 2200, the service computing device 8030, and the remote computing device 8040 may be in communication with other elements of the scientific instrument support system 8000 via communication pathways 8008. The communication pathways 8008 may communicatively couple the interface devices 7006 of different ones of the elements of the scientific instrument support system 8000, as shown, and may be wired or wireless communication pathways (e.g., in accordance with any of the communication techniques discussed herein with reference to the interface devices 7006 of the computing device 7000 of FIG. 7). The particular scientific instrument support system 8000 depicted in FIG. 8 includes communication pathways between each pair of the scientific instrument 2100, the user local computing device 2200, the service computing device 8030, and the remote computing device 8040, but this “fully connected” implementation is purely illustrative, and in various embodiments, various ones of the communication pathways 8008 may be absent. For example, in some embodiments, a service computing device 8030 may not have a direct communication pathway 8008 between its interface device 7006 and the interface device 7006 of the scientific instrument 2100, but may instead communicate with the scientific instrument 2100 via the communication pathway 8008 between the service computing device 8030 and the user local computing device 2200 and the communication pathway 8008 between the user local computing device 2200 and the scientific instrument 2100. The scientific instrument 2100 may comprise any appropriate scientific instrument, such as, for example, a TOFMS or LC-MS instrument.

According to an example embodiment disclosed above, e.g., in reference to any one or any combination of some or all of FIGS. 1-8, provided is a support apparatus for a scientific instrument, the support apparatus comprising: first logic configured to transfer portions of a data structure acquired with one or more detectors of the scientific instrument to a client device, the data structure being stored in a data storage connected to the first logic via a network, the portions being identified to the first logic in a sequence of data requests received from the client device; second logic configured to identify parts of the data structure based on at least one of a data-access pattern in the sequence of data requests and a buffer size for a storage device locally connected to the first logic; and third logic configured to download the parts from the data storage to the storage device, wherein the first logic is configured to switch a data transfer path for the client device from being end-connected to the data storage to being end-connected to the storage device when a requested portion of the data structure is in the parts downloaded to the storage device via the third logic.

In some embodiments of the above apparatus, the scientific instrument comprises at least one of a mass spectrometer and a chromatography system.

In some embodiments of any of the above apparatus, the second logic is configured to identify the parts of the data structure using a predictive algorithm configured to detect the data-access pattern in a space defined by one or more attributes selected from the group of attributes consisting of: a scan order in a sequence of mass-spectrometer scans, a sequence of mass ranges, relative timing of a mass-spectrometer scan and a chromatographic peak in a corresponding chromatogram, and a chemical compound library.

The In some embodiments of any of the above apparatus, structure has a size in a range between 1 GB and 100 GB and includes data from pluralities of mass spectrometer scans and detector channels corresponding to a single analyte injection.

In some embodiments of any of the above apparatus, the third logic is configured to perform a background download to download the parts, the background download occurring concurrently with a transfer via the first logic of one or more of the portions of the data structure from the data storage to the client device.

In some embodiments of any of the above apparatus, the first logic is configured to dynamically select a suitable data reader from a plurality of data readers based on the data transfer path.

In some embodiments of any of the above apparatus, the plurality of data readers includes: a first data reader suitable for reading from the data storage; and a different second data reader suitable for reading from the storage device.

In some embodiments of any of the above apparatus, the plurality of data readers is implemented as a plurality of application plugins.

In some embodiments of any of the above apparatus, the data storage is selected from the group consisting of: a web-based object storage, an enterprise data-storage platform, a micro service platform, a network-attached storage, and a storage area network.

In some embodiments of any of the above apparatus, in response to a subsequent data request received from the client device, the first logic is configured to: obtain an availability status for a subsequent portion of the data structure specified in the subsequent data request; transfer the subsequent portion of the data structure to the client device from the storage device when the availability status is “available”; and transfer the subsequent portion of the data structure to the client device from the data storage when the availability status is “not available.”

In some embodiments of any of the above apparatus, the first logic is configured to switch the data transfer path in response to a message from the third logic reporting a download completion event.

In some embodiments of any of the above apparatus, the data structure has a binary format suitable for recording, packaging, and transfer of experimental data acquired via multiple ones of the detectors of the scientific instrument.

According to another example embodiment disclosed above, e.g., in reference to any one or any combination of some or all of FIGS. 1-8, provided is an automated method performed via a computing device for providing scientific instrument support, the method comprising: transferring portions of a data structure acquired with one or more detectors of a scientific instrument to a client device, the data structure being stored in a data storage connected via a network to the computing device, the portions being identified to the computing device in a sequence of data requests received from the client device; identifying parts of the data structure based on at least one of a data-access pattern in the sequence of data requests and a buffer size for a storage device locally connected to the computing device; downloading the parts from the data storage to the storage device; and switching a data transfer path for the client device from being end-connected to the data storage to being end-connected to the storage device when a requested portion of the data structure is in the parts downloaded to the storage device via the computing device.

In some embodiments of the above method, the scientific instrument comprises at least one of a mass spectrometer and a chromatography system.

In some embodiments of any of the above methods, the method further comprises identifying the parts of the data structure using a predictive algorithm configured to detect the data-access pattern in a space defined by one or more attributes selected from the group of attributes consisting of: a scan order in a sequence of mass-spectrometer scans, a sequence of mass ranges, relative timing of a mass-spectrometer scan and a chromatographic peak in a corresponding chromatogram, and a chemical compound library.

In some embodiments of any of the above methods, the downloading comprises performing a background download concurrently with a transfer via the computing device of one or more of the portions of the data structure from the data storage to the client device.

In some embodiments of any of the above methods, the method further comprises dynamically selecting a suitable data reader from a plurality of data readers based on the data transfer path.

In some embodiments of any of the above methods, the plurality of data readers is implemented as a plurality of application plugins.

In some embodiments of any of the above methods, the data structure has a binary format suitable for recording, packaging, and transfer of experimental data acquired via multiple ones of the detectors of the scientific instrument.

According to yet another example embodiment disclosed above, e.g., in reference to any one or any combination of some or all of FIGS. 1-8, provided is one or more non-transitory computer readable media having instructions thereon that, when executed by one or more computing devices for providing scientific instrument support, cause the one or more computing devices to perform any one of the above automated methods.

What is claimed is:

1. A support apparatus for a scientific instrument, the support apparatus comprising:
first logic configured to transfer portions of a data structure acquired with one or more detectors of the scientific instrument to a client device, the data structure being stored in a data storage connected to the first logic via a network, the portions being identified to the first logic in a sequence of data requests received from the client device;
second logic configured to identify parts of the data structure based on at least one of a data-access pattern in the sequence of data requests and a buffer size for a storage device locally connected to the first logic; and
third logic configured to download the parts from the data storage to the storage device,
wherein the first logic is configured to switch a data transfer path for the client device from being end-connected to the data storage to being end-connected to the storage device when a requested portion of the data structure is in the parts downloaded to the storage device via the third logic.

2. The support apparatus of claim 1, wherein the scientific instrument comprises at least one of a mass spectrometer and a chromatography system.

3. The support apparatus of claim 2, wherein the second logic is configured to identify the parts of the data structure using a predictive algorithm configured to detect the data-access pattern in a space defined by one or more attributes selected from the group of attributes consisting of:
a scan order in a sequence of mass-spectrometer scans,
a sequence of mass ranges,
relative timing of a mass-spectrometer scan and a chromatographic peak in a corresponding chromatogram, and
a chemical compound library.

4. The support apparatus of claim 2, wherein the data structure has a size in a range between 1 GB and 100 GB and includes data from pluralities of mass spectrometer scans and detector channels corresponding to a single analyte injection.

5. The support apparatus of claim 1, wherein the third logic is configured to perform a background download to download the parts, the background download occurring concurrently with a transfer via the first logic of one or more of the portions of the data structure from the data storage to the client device.

6. The support apparatus of claim 1, wherein the first logic is configured to dynamically select a suitable data reader from a plurality of data readers based on the data transfer path.

7. The support apparatus of claim 6, wherein the plurality of data readers includes:
a first data reader suitable for reading from the data storage; and
a different second data reader suitable for reading from the storage device.

8. The support apparatus of claim 6, wherein the plurality of data readers is implemented as a plurality of application plugins.

9. The support apparatus of claim 1, wherein the data storage is selected from the group consisting of:
a web-based object storage,
an enterprise data-storage platform,
a micro service platform,
a network-attached storage, and
a storage area network.

10. The support apparatus of claim 1, wherein, in response to a subsequent data request received from the client device, the first logic is configured to:
obtain an availability status for a subsequent portion of the data structure specified in the subsequent data request;
transfer the subsequent portion of the data structure to the client device from the storage device when the availability status is “available”; and
transfer the subsequent portion of the data structure to the client device from the data storage when the availability status is “not available.”

11. The support apparatus of claim 1, wherein the first logic is configured to switch the data transfer path in response to a message from the third logic reporting a download completion event.

12. The support apparatus of claim 1, wherein the data structure has a binary format suitable for recording, packaging, and transfer of experimental data acquired via multiple ones of the detectors of the scientific instrument.

13. An automated method performed via a computing device for providing scientific instrument support, the method comprising:
transferring portions of a data structure acquired with one or more detectors of a scientific instrument to a client device, the data structure being stored in a data storage connected via a network to the computing device, the portions being identified to the computing device in a sequence of data requests received from the client device;
identifying parts of the data structure based on at least one of a data-access pattern in the sequence of data requests and a buffer size for a storage device locally connected to the computing device;
downloading the parts from the data storage to the storage device; and
switching a data transfer path for the client device from being end-connected to the data storage to being end-connected to the storage device when a requested portion of the data structure is in the parts downloaded to the storage device via the computing device.

14. The automated method of claim 13, wherein the scientific instrument comprises at least one of a mass spectrometer and a chromatography system.

15. The automated method of claim 14, further comprising identifying the parts of the data structure using a predictive algorithm configured to detect the data-access pattern in a space defined by one or more attributes selected from the group of attributes consisting of:
a scan order in a sequence of mass-spectrometer scans,
a sequence of mass ranges,
relative timing of a mass-spectrometer scan and a chromatographic peak in a corresponding chromatogram, and
a chemical compound library.

16. The automated method of claim 13, wherein the downloading comprises performing a background download concurrently with a transfer via the computing device of one or more of the portions of the data structure from the data storage to the client device.

17. The automated method of claim 13, further comprising dynamically selecting a suitable data reader from a plurality of data readers based on the data transfer path.

18. The automated method of claim 17, wherein the plurality of data readers is implemented as a plurality of application plugins.

19. The automated method of claim 13, wherein the data structure has a binary format suitable for recording, packaging, and transfer of experimental data acquired via multiple ones of the detectors of the scientific instrument.

20. One or more non-transitory computer readable media having instructions thereon that, when executed by one or more computing devices for providing scientific instrument support, cause the one or more computing devices to perform the automated method of claim 13.
